(19) United States
(12) Patent Application Publication
(10) Pub. No.: US 2026/0162127 A1
(43) Pub. Date: Jun. 11, 2026

(54) METHOD AND SYSTEM FOR PRODUCT AUTHENTICATION

(71) Applicant: CONFIRMIO EHF., Reykjavík (IS)

(72) Inventors: Thorarinn KRISTJANSSON, Reykjavík (IS); Andres BERTELSEN, Selfoss (IS)

(21) Appl. No.: 19/412,048

(22) Filed: Dec. 8, 2025

Related U.S. Application Data
(60) Provisional application No. 63/729,607, filed on Dec. 9, 2024.

(30) Foreign Application Priority Data
Dec. 9, 2024 (EP) 24218369.7
Aug. 22, 2025 (EP) 25197622.1

(51) Int. Cl. G06Q 30/018

(52) U.S. Cl. CPC G06Q 30/018

(57) ABSTRACT

A method and a system for product authentication are provided. A verification is generated for the product linking spatiotemporal data associated with the product to the verification code. The verification code is configured to be scanned by a scanning device and utilized in performing spatiotemporal verification of the product. Generating the verification code includes using a computer device associated with a unique digital identifier, wherein the unique digital identifier comprises metadata linking the computer device to a legal entity controller of the computer device, metadata uniquely identifying the computer device, and spatiotemporal data. This enables secure and tamper-resistant product authentication by ensuring that each verification code is cryptographically tied to both the authorized entity and the specific device that created it.

### FIELD OF THE INVENTION

The present invention relates to a system and a method for product authentication where the product includes a physical object.

### BACKGROUND OF THE INVENTION

In today's interconnected world, the demand for reliable and verifiable proof has become critical across a wide range of domains, from global commerce to personal travel. Counterfeiting and fraud are escalating challenges that undermine industries, damage brand value, and place consumers at risk. In commercial settings, counterfeit products not only cause substantial financial losses for legitimate businesses but also erode consumer trust and, in some cases, create serious safety hazards.

To combat these threats, verification mechanisms such as QR codes and other forms of digital identifiers have been developed to link a physical product with corresponding proof of authenticity. However, conventional solutions remain vulnerable: QR codes, barcodes, and verification tags can often be tampered with, copied, or fraudulently reproduced. This undermines their effectiveness, particularly in high-value or sensitive applications where security and trust are paramount.

These limitations highlight a pressing need for a new class of verification codes that are tamper-resistant, cryptographically protected, and capable of being reliably verified across distributed systems. By ensuring that once a verification code is generated and linked to a product it cannot be altered, counterfeited, or misused, such a solution would provide a significant improvement over existing methods.

Accordingly, there is a need for a verification system where codes are inherently tamper-resistant, cryptographically secure, and verifiable in a trustworthy manner. Such a system would enhance the integrity of product authentication, safeguard transactions, and strengthen consumer confidence, thereby offering industries a robust defense against fraud.

### SUMMARY OF THE INVENTION

It is an object of the present invention to address the above-mentioned issues by introducing a verification system that enables secure and scalable authentication of physical products.

A further object of the present invention is to provide a flexible solution suitable for any type of product or brand, allowing manufacturers, distributors, and retailers to ensure product authenticity in a manner that strengthens consumer confidence, preserves brand integrity, and effectively combats counterfeiting and fraud.

In general, the invention preferably seeks to mitigate, alleviate, or eliminate one or more of the above-mentioned disadvantages of the prior art, singly or in combination. In particular, it may be seen as an object of embodiments of the present invention to provide a tamper-resistant verification system that allows for secure and trustworthy authentication of physical products, thereby protecting supply chains, deterring fraudulent activity, and ensuring transparency across distribution channels.

According to a first aspect of the invention, a method is provided for product authentication, comprising:
generating, by a verification code manufacturing device having a processor, a cryptographically generated verification code for the product;
linking, by a processing unit, spatiotemporal data for the product to the verification code, the spatiotemporal data including at least one of a timestamp and a geographic coordinate corresponding to a location and a time of generation of the verification code, where the verification code is configured to be scanned, by a scanning device executing verification instructions, and utilized in performing spatiotemporal verification for the product;
wherein generating the verification code comprises:
using a computer device associated with a unique digital identifier, the unique digital identifier comprising metadata, including:
metadata that links the computer device to a legal entity controller of the computer device,
metadata that uniquely identifies the computer device, and
the spatiotemporal data,
wherein the metadata is stored on a distributed ledger system, thereby providing an immutable record of the verification code and associated spatiotemporal data.

This method thus provides a secure and tamper-resistant product authentication mechanism by embedding spatiotemporal data into the verification code that is configured for scanning and verification. Because the verification code is cryptographically tied to a unique digital identifier of the verification code manufacturing device, which includes metadata linking the device to a legal entity controller as well as metadata uniquely identifying the device itself, the authenticity of the code can be reliably established. By including the spatiotemporal data including the timestamp and geographic coordinates, as metadata provides an additional security layer, since the code is not only bound to the manufacturing device but also to the specific time and location of its generation. This makes it computationally and practically infeasible for counterfeiters to replicate or reuse codes without creating detectable inconsistencies in the expected spatiotemporal patterns. Moreover, such metadata enables enhanced auditability by providing a verifiable trail of when and where codes were issued, thereby supporting forensic analysis and regulatory compliance. As an example, compared to conventional QR code or centralized verification solutions, the invention improves resistance to counterfeiting and fraud, enhances auditability through verifiable spatiotemporal data, and strengthens trust in product authentication across industries and consumer interactions.

Furthermore, the use of a distinct digital identifier associated with the computer device ensures that the verification code is traceable to a specific device and the legal entity responsible for its control. This arrangement facilitates accountability and traceability, as the metadata includes information about the device and its controller, ensuring the verification process is connected to a reliable source.

Storing the metadata on a distributed ledger system, such as a blockchain, creates an immutable record of the verification code and the associated spatiotemporal data. This prevents unauthorized modifications and ensures the integrity of the authentication data over time. The distributed ledger system also facilitates transparency and trust among stakeholders, as the records are accessible and capable of being verified.

To summarize, the method addresses the problem of counterfeit products and unauthorized modifications by providing a secure, traceable, and tamper-evident mechanism for product authentication. The approach is applicable in industries where verifying product authenticity and provenance is of significant importance, such as pharmaceuticals, luxury goods, and electronics.

The term legal entity controller may be selected from, but is not limited to: a natural person, a company, a corporation, a partnership, a joint venture, a consortium, a government agency, a municipality, a non-profit organization, a research institute, a trust, a foundation, a cooperative, or another juridical entity having ownership, control, or administrative responsibility for the computer device.

This arrangement ensures that the authentication is adaptable to a diverse array of organizational structures and user types, thereby enhancing the scope of its application across various industries and use cases.

By explicitly defining the legal entity controller as encompassing diverse entities, the method accommodates various operational scenarios, such as supply chain management, regulatory compliance, and product ownership tracking. This flexibility allows the method to be implemented in environments with varying legal and administrative requirements, ensuring compatibility with different business models and legal frameworks.

Furthermore, this arrangement enhances the reliability of the authentication process by ensuring that the computer device is linked to a verified and accountable entity, which can be a person or organization. This reduces the risk of fraudulent activities, such as unauthorized generation of verification codes, and strengthens the trustworthiness of the product authentication system.

In an embodiment, the metadata is generated by:
obtaining, via the computer device, characteristic data of the legal entity controller;
transmitting, to a computer system connected to the computer device, the characteristic data together with data uniquely identifying the computer device;
generating, by the computer system, a verification message based on the received data;
transmitting the verification message to the computer device; and
upon receiving confirmation of the verification message from the legal entity controller;
using the characteristic data of the legal entity controller together with the data uniquely identifying the computer device as said metadata.

Accordingly, it is ensured that the metadata used for the product authentication is both verifiable and resistant to manipulation. By requiring that characteristic data of the legal entity controller together with data uniquely identifying the computer device be transmitted to a connected computer system for verification, and by further requiring confirmation from the legal entity controller before the metadata is finalized, the present invention prevents unauthorized or fraudulent generation of metadata. This multi-step process establishes a secure binding between the legal entity controller and the computer device, thereby reducing the risk of spoofing, tampering, or impersonation. As a result, the method provides a more trustworthy foundation for generating verification codes and strengthens the overall integrity of product authentication processes.

In practical application, this method provides a robust mechanism for ensuring that the verification codes generated by the computer device are traceable to a legitimate and verified entity. This is particularly advantageous in scenarios where product authentication and traceability are of significant importance, such as supply chain management, counterfeit prevention, and regulatory compliance. By linking the metadata to a distributed ledger system, the method ensures an immutable record of the verification process, further enhancing trust and transparency in the authentication system.

For example, consider a scenario where facial recognition data is used as the characteristic data of a user who is the legal entity controller of a computer device, and spatiotemporal data is used as a further verification.

The user initiates a request to send an authenticated email from the user's computer device.

The computer device captures the user's facial recognition data using an integrated camera.

The computer device also captures spatiotemporal data, such as the current geographic coordinates (e.g., via GPS) and a timestamp corresponding to the time and location of the authentication attempt.

The captured facial recognition data, the spatiotemporal data, and an identifier specific to the computer device are transmitted to a remote computer system.

The computer system compares the received facial recognition data with previously stored characteristic data of the authorized user (legal entity controller) associated with that device.

The computer system also compares the received spatiotemporal data with the expected or previously registered spatiotemporal data associated with the user and device.

Upon a successful match of both the facial recognition data and the spatiotemporal data, the computer system generates a verification message and transmits the verification message back to the computer device.

The user confirms receipt of the verification message, for example by entering a code or providing a biometric confirmation.

The system then uses the verified facial recognition data, the specific device identifier, and the spatiotemporal data as metadata, which is stored on a distributed ledger.

When the email is sent, the content includes a cryptographic signature or reference to the verification metadata, indicating that the email originated from the verified user and device at a specific time and location.

If someone else, located at a different place (e.g., on the other side of the continent), attempts to send an email using the same device credentials but fails the facial recognition verification and/or the spatiotemporal data does not match the expected parameters, the system will not generate the verification metadata or allow the email to be authenticated in the same manner.

As a result, recipients and third parties can verify, based on the metadata stored on the distributed ledger, that the email was genuinely sent by the authorized user from the expected location and device at the correct time, thereby preventing impersonation or fraudulent activity.

Typically, the entire process, including biometric capture, spatiotemporal data acquisition, transmission, verification, and confirmation, occurs within a time frame ranging from seconds to milliseconds, ensuring minimal delay and a seamless user experience.

The term computer system may, according to the present invention, be understood as any type of computer platform, application programming interface (API), or network-connected infrastructure capable of performing the described functions. This includes, but is not limited to, server platforms, cloud-based systems, distributed ledger or blockchain networks, enterprise back-end systems, web services, and dedicated authentication platforms. The computer system may further encompass combinations of hardware and software resources, virtualized environments, or third-party service providers that are configured to process, verify, and manage the data required for generating and validating the metadata and verification codes.

In an embodiment, the unique digital identifier for the computer device is stored locally on the computer device and/or remotely by the computer system, where the method further comprises, prior to generating a verification code for the product, a pre-step comprising:
capturing characteristic data of an operator operating the computer device,
comparing the captured characteristics data with the stored characteristics data of the legal entity controller, where in case of a match indicating that the operator is the legal entity controller or is authorized as part of the legal entity controller, and
generating the verification code for the product.

As already stated, the legal entity controller may be an agency, company, or other organization with which the user is affiliated, i.e. an umbrella-type legal entity to which the user belongs or for which the user is working. For example, the legal entity controller may be a production facility where only a limited number of authorized persons are permitted to generate verification codes on behalf of the facility. This ensures that the authority to issue such codes is strictly confined to trusted operators acting under the responsibility of the legal entity controller, thereby preventing unauthorized personnel from creating fraudulent codes.

It is therefore ensured that the verification code can only be generated when both the computer device and its operator are verified. By storing the unique digital identifier of the device locally and/or remotely, and by requiring a pre-step in which captured characteristic data of the operator is compared with stored data of the legal entity controller, the method prevents unauthorized or fraudulent use of the device for generating verification codes. This dual-layer verification, linking the device identity with operator authentication, significantly reduces or eliminates risks of impersonation, misuse, and tampering, thereby enhancing the overall security and trustworthiness of the product authentication process.

In an embodiment, the method further comprises:
comparing the spatiotemporal location data of the computer device with the spatiotemporal location data associated with the unique digital identifier,
wherein the step of generating the verification code for the product is further based on a match of the spatiotemporal location data.

As already mentioned, the fact that the generation of the verification code depends not only on authenticating the device and operator, but also on verifying spatiotemporal data and additional security layer is added referring to the geographic location and the time of use of the computer device. For example, this may include GPS coordinates and a timestamp showing where and when the verification code request was made. By requiring a match between the current spatiotemporal data of the device and the spatiotemporal data linked to its unique digital identifier, the method prevents fraudulent attempts to generate codes from unauthorized locations or at unexpected times. This additional safeguard strengthens protection against misuse and ensures that verification codes are only issued in trusted contexts.

As an example, each product, which may be a physical item such as a piece of furniture, receives a unique verification code. For instance, if a production facility manufactures a batch of 1,000 chairs, then 1,000 unique verification codes are generated, one for each individual chair. If a counterfeiter attempts to replicate the batch, the fraudulent company would have to reproduce all 1,000 unique verification codes to convincingly copy the products. This would require not only copying the visual representation of the code (e.g., a QR code) but also reproducing the underlying metadata and spatiotemporal links associated with each code. Such large-scale duplication is practically impossible. At best, a fraudulent person might manage to copy a single verification code from an authentic product and attach it to a counterfeit chair. However, this only results in multiple chairs appearing with the same verification code. When scanned, this duplication would immediately be detected in the verification system (since a single code is expected to be associated with only one authentic product). Thus, even if one verification code is copied, the fraudulent product can be flagged as suspicious or invalid.

Accordingly, the present method ensures that large-scale counterfeiting attempts become infeasible, while small-scale copying attempts are easily detected by the verification infrastructure, thereby protecting both the authenticity of the products and the trust of end users.

In an embodiment, the product is a physical product, and the verification code is physically attached to the product, for example by means of a label, tag, engraving, or other marking directly affixed to the product or its packaging. The physical attachment ensures that the verification code is inseparably linked to the product itself, making it readily accessible for scanning by a user or automated reader at any point in the product's lifecycle, including manufacturing, distribution, retail, or post-sale verification.

In an embodiment, the digital identifier comprises a non-fungible token (NFT) representing the computer device.

The use of an NFT provides a cryptographically unique and immutable record that cannot be duplicated or altered, thereby ensuring that the identity of the computer device is securely anchored in a distributed ledger. The NFT creates a verifiable and tamper-resistant link between the computer device and its legal entity controller, which prevents spoofing or cloning of device identifiers. This enhances transparency, enables decentralized verification without reliance on a single trusted authority, and strengthens the overall integrity of the product authentication process.

This arrangement ensures that the authentication is adaptable to a diverse array of organizational structures and user types, thereby enhancing the scope of its application across various industries and use cases.

By explicitly defining the legal entity controller as encompassing diverse entities, the method accommodates various operational scenarios, such as supply chain management, regulatory compliance, and product ownership tracking. This flexibility allows the system to be implemented in environments with varying legal and administrative requirements, ensuring compatibility with different business models and legal frameworks.

Furthermore, this arrangement enhances the reliability of the authentication process by ensuring that the computer device is linked to a verified and accountable entity, which can be a person or organization. This reduces the risk of fraudulent activities, such as unauthorized generation of verification codes, and strengthens the trustworthiness of the product authentication system.

In an embodiment, the method further comprises associating a non-fungible product token (NFT-p) with the product, wherein the NFT-p comprises metadata including, but not limited to, one or more of: product authentication data, product certification data, transport-related information, distribution center-related information, retail-related information, purchase-related information, manufacturing-related information, origin or provenance information, quality control or inspection data, warranty or service-related information, regulatory or compliance-related information, customs or import/export-related information, ownership history or transfer records, maintenance or repair-related information, usage or operational data, and recycling, disposal, or sustainability-related information.

Accordingly, the NFT-p provides a permanent, tamper-resistant, and verifiable digital twin of the physical product, enabling traceability across its entire lifecycle, the supply chain etc. By anchoring product-specific data in an immutable token, fraudulent substitution, forgery, or data manipulation is prevented. When combined with the NFT representing the computer device a dual-layer authentication framework is established in which both the source of the verification code and the product itself are cryptographically secured. This not only enhances transparency and trust in the product's provenance and authenticity but also enables decentralized, cross-platform verification without dependence on a central authority.

Also, by associating NFT-p with the product, the method enables the storage and retrieval of detailed metadata related to the product's lifecycle, including authentication, certification, transportation, distribution, retail, purchase, manufacturing, provenance, quality control, warranty, regulatory compliance, customs, ownership history, maintenance, usage, and sustainability information. This arrangement provides a decentralized and tamper-resistant mechanism for tracking and verifying the product's authenticity and history, leveraging the immutability and transparency characteristics of distributed ledger systems.

The inclusion of diverse metadata categories ensures comprehensive traceability and accountability throughout the product's lifecycle, addressing challenges such as counterfeit prevention, regulatory compliance, and consumer trust. For example, the ability to store and access provenance information allows users to verify the origin of the product, while warranty and service-related data facilitate post-purchase support. Additionally, the integration of recycling and sustainability-related information promotes environmentally responsible practices.

This approach differs from traditional methods by utilizing NFTs to represent products and their associated metadata in a distinct manner, ensuring that the data remains immutable and accessible across various stages of the product's journey. The use of blockchain technology further enhances security and reliability, as the data cannot be altered without consensus, providing a robust solution for product authentication and lifecycle management.

In an embodiment, a new non-fungible product token (NFT-p) is generated each time the NFT-p is scanned during a transport operation, wherein the newly generated NFT-p contains at least updated spatiotemporal data representing the location and time at which the scanning took place.

The successive creation of NFT-p instances establishes an immutable sequence of product states, each anchored in time and space, thereby forming a verifiable chain of custody across the transport and distribution process. The newly created NFT-p may further inherit or reference previous NFT-p data, ensuring continuity of product history while preventing overwriting or tampering with earlier records.

The product's movement can therefore be tracked with a high degree of accuracy and trust, since every scan results in a cryptographically verifiable record that reflects where and when the product was last handled. This approach eliminates the risk of falsifying transport records, backdating entries, or concealing unauthorized diversions in the supply chain, e.g. at distribution centers, retailers etc. meaning that a single product may have several, tens or hundreds such NFT-p's. By leveraging a sequence of NFTs rather than a single mutable record, the system provides an immutable audit trail that enhances transparency, strengthens regulatory compliance, and allows stakeholders to reliably verify the authenticity and provenance of a product at any point in its lifecycle.

Furthermore, the implementation of a distributed ledger system ensures that the updated NFT-p records are securely stored and cannot be altered retroactively, enhancing trust and reliability in the authentication process. This arrangement is especially beneficial for industries that prioritize product authenticity and traceability, such as pharmaceuticals, luxury goods, and food supply chains.

For example, in the case of a pharmaceutical product, each scan during transportation could generate a new NFT-p with updated spatiotemporal data, allowing stakeholders to verify the authenticity of the product and confirm that the product has been stored and transported under the required conditions. This reduces the risk of counterfeit drugs entering the market and supports adherence to regulatory requirements.

In an embodiment, if the operator of the computer device is not identified as the legal entity controller, i.e. someone that is not authorized to do so within a factory/company, the method may be configured to inform that person that the verification code will not be generated.

In an embodiment, the method further comprises obtaining, via a computer device operated by a user, characteristic data of the user for generating a unique identifier (ID) or cryptographic ID. The unique identifier is configured to serve as a digital signature of the user within the computer system, e.g., an API-based platform. The computer device may include said mobile device operated by the user.

Each user is thereby assigned a unique identifier, a Cryptographic ID, which functions as the user's personal digital signature and is exclusively owned by the user within the platform. The Cryptographic ID can be utilized in different contexts, including both personal and professional activities. When the platform establishes this access and securely links the Cryptographic ID to the user's biometric data, a non-transferable and non-forgeable digital identity is created.

For example, if a user changes employment to an organization that subscribes to the computer system, e.g. said platform which may be considered as an identification platform or Cryptographic ID platform, the user can authorize the new employer to access their Cryptographic ID. Consequently, all employees registered on the platform are reliably verified, and all communications, emails, and related transactions can be securely associated with the employee's unique digital signature.

Accordingly, each user is thus provided with a digital identity that is both unique and inseparably tied to the individual, thereby enabling secure, verifiable, and portable authentication across multiple organizational contexts without loss of integrity or risk of impersonation

Thus, by generating a distinct identifier or cryptographic ID for the user based on their characteristic data, the method ensures secure and personalized authentication of the user within the computer system. This arrangement reduces the risk of unauthorized access or identity fraud, as the cryptographic ID is tied to specific user data that is challenging to replicate or falsify.

The use of characteristic data to create the identifier provides a robust mechanism for verifying the user's identity, enabling the computer system to distinguish between different users with high accuracy. This is particularly advantageous in scenarios where multiple users interact with the same computer system, ensuring that each user is distinctly identified and authenticated.

Additionally, the cryptographic ID serves as a digital signature, which can be utilized for secure transactions, data integrity verification, or other operations requiring user authentication. This practical application enhances the security and reliability, especially in environments where sensitive data or operations are involved.

For instance, in a pharmaceutical supply chain, a delivery driver is registered by capturing their facial recognition data, which is used to generate a cryptographic ID specific to that driver. This cryptographic ID is securely stored on a central computer. When the driver later delivers a shipment and scans the product at a distribution center, the stored cryptographic ID is retrieved to verify the driver's identity before allowing the authentication process to proceed. This ensures that only pre-registered, verified individuals can authenticate products at important points in the supply chain, and that each authentication event is traceable to a specific, authorized user.

According to a second aspect of the invention, a system is provided for product authentication, comprising:
a verification code manufacturing device having a processor for generating a cryptographically generated verification code for the product;
a spatiotemporal data module configured to obtain spatiotemporal data associated with the product and link the spatiotemporal data to the verification code, the spatiotemporal data including at least one of a timestamp and a geographic coordinate corresponding to a location and a time of generation of the verification code, where the verification code is configured to be scanned, by a scanning device executing verification instructions, and utilized in performing spatiotemporal verification for the product;
wherein the verification code manufacturing device is associated with a unique digital identifier, the unique digital identifier comprising metadata, including metadata that links the computer device to a legal entity controller of the computer device, metadata that uniquely identifies the computer device, and the spatiotemporal data, wherein the metadata is stored on a distributed ledger system, thereby providing an immutable record of the verification code and associated spatiotemporal data.

The verification code manufacturing device may in an alternative embodiment comprise a processor and a memory for storing the metadata including, and the processor may be configured to execute instructions for generating the verification code and for linking spatiotemporal data to the verification code based on the stored unique digital identifier.

A system is thus provided that enables secure and tamper-resistant product authentication by combining spatiotemporal data with a verification code that is cryptographically tied to a uniquely identifiable device under the control of a legal entity. Because the verification code is generated by a verification code manufacturing device that is associated with a unique digital identifier, and because that identifier contains both metadata linking the device to a specific legal entity controller and metadata uniquely identifying the device itself, unauthorized or fraudulent devices cannot generate valid codes. This ensures that each verification code is anchored not only to the time and place of product handling but also to a verifiable source device and its controlling entity. The result is a multi-layer authentication mechanism that prevents spoofing, forgery, or manipulation of verification codes, thereby improving the integrity, traceability, and trustworthiness of product authentication across the entire lifecycle of the product.

Moreover, by storing the metadata on a distributed ledger system, such as a blockchain, provides an immutable and tamper-evident record of the verification code and the associated spatiotemporal data. This ensures that the authentication data cannot be altered or erased, offering a robust solution for maintaining trust in the process of authenticating the product.

Further, the system's ability to scan the verification code and utilize the scanned data for spatiotemporal verification enables real-time validation of the product's authenticity and movement. This practical application addresses the problem of counterfeit goods and enhances consumer confidence in the genuineness of purchased products.

By organizing verification records into blocks with cryptographic references to preceding blocks, the system creates a secure chain of records that can be audited to verify the product's history. This arrangement provides a scalable and efficient method for managing authentication data across multiple products and transactions.

The term scanning device according to the present invention may be understood as any hardware, software, or combined component configured to read a verification code and initiate a corresponding verification process. This includes, for example, (i) an optical reader such as a camera, image sensor, or barcode/QR code reader configured to capture and interpret a visually represented verification code, and (ii) a software-based module, application, or application programming interface (API) configured to extract or interpret a verification code embedded in a digital file or its metadata. Accordingly, the scanning device may encompass physical scanners and/or digital verification modules.

In an embodiment, the verification code is a cryptographically generated code configured to prevent duplication or forgery.

Accordingly, by employing cryptographic techniques to generate the verification code, the system prevents unauthorized duplication or manipulation of the code, thereby strengthening protection against counterfeiting.

In an embodiment, the distributed ledger system comprises a blockchain system in which verification records for the product are organized into blocks, each block comprising a plurality of transactions and a cryptographic reference to a preceding block, thereby forming a tamper-evident chain of blocks representing spatiotemporal verification events.

The use of a blockchain system ensures the integrity and immutability of the verification records. By organizing the records into cryptographically linked blocks, the system prevents unauthorized modifications or tampering with the data. Any attempt to alter a record would require changes to all subsequent blocks in the chain, which is computationally infeasible, thereby enhancing the security and reliability of the stored information.

Additionally, the cryptographic reference to preceding blocks provides a mechanism for traceability and transparency. This arrangement allows for the chronological tracking of spatiotemporal verification events, enabling stakeholders to verify the authenticity and history of the product during various stages of its lifecycle. This is especially beneficial in supply chain management, where the provenance and movement of goods are significant for maintaining compliance, quality control, and fraud prevention.

The blockchain-based approach also facilitates decentralized data storage, reducing the risk of single points of failure and ensuring that the verification records remain accessible and secure even in the event of system disruptions. This is a significant improvement over traditional centralized databases, which are more vulnerable to data breaches and loss.

In an embodiment, the system further comprises a processor configured to generate a digital certificate upon purchase of the product, the certificate including at least the brand name of the product, place of manufacture, and purchaser information.

Thus, the system enables the generation of a digital certificate upon the purchase of a product, which may include specific information such as the brand name, place of manufacture, and purchaser information. By incorporating these details into a digital certificate, the system provides a reliable and verifiable means of authenticating the product and verifying its origin.

This arrangement ensures that the authenticity and origin of the product can be verified at any point in the product's lifecycle, reducing the risk of counterfeit goods entering the supply chain. The inclusion of purchaser information in the certificate further facilitates traceability and accountability, enabling the identification of the product's ownership and purchase history.

The digital certificate serves as a secure and tamper-resistant record, leveraging cryptographic techniques to prevent unauthorized modifications. This enhances trust and transparency in transactions involving the product, particularly in industries where authenticity and provenance are highly valued, such as luxury goods, pharmaceuticals, or electronics.

Additionally, the digital certificate can be utilized in various practical applications, such as warranty claims, product recalls, or regulatory compliance checks, thereby streamlining processes and reducing administrative overhead. This feature provides a robust mechanism for ensuring product integrity and compliance with industry standards.

In an embodiment, the metadata is derived by:
obtaining, via the computer device, characteristic data of the legal entity controller;
transmitting, to a computer system connected to the computer device, the characteristic data together with data uniquely identifying the computer device;
generating, by the computer system, a verification message based on the received data;
transmitting the verification message to the computer device; and
upon receiving confirmation of the verification message from the legal entity controller;
using the characteristic data of the legal entity controller together with the data uniquely identifying the computer device as said metadata,
wherein the legal entity controller comprises at least one of: a natural person, a company, a corporation, a partnership, a joint venture, a consortium, a government agency, a municipality, a non-profit organization, a research institute, a trust, a foundation, a cooperative, or another juridical entity having ownership, control, or administrative responsibility for the computer device,
wherein the unique digital identifier associated with the computer device is stored in a memory resource local to the computer device and/or in a memory resource remote from the computer device and accessible by the computer system,
where the system further comprises a biometric capturing device configured to, prior to generating a verification code for the product, capturing characteristic data of an operator operating the computer device,
a processor configured for comparing the captured characteristics data with the stored characteristics data of the legal entity controller and generating, in case of a match, the verification code for the product,
the processor is further configured for comparing the spatiotemporal location data of the computer device with the spatiotemporal location data associated with the unique digital identifier, where the step of generating the verification code for the product is further based on a match of the spatiotemporal location data.

This arrangement enables secure and tamper-resistant code generation, precise tracking of the product's location and time of verification, and clear attribution of the verification process to an authenticated device and controller. Storing the data on a distributed ledger ensures the record cannot be altered, supporting reliable product authentication and traceability. For example, manufacturers can use this system to generate and record verification codes, allowing downstream parties to confirm product authenticity and provenance.

In an embodiment, the verification code manufacturing device comprises:
a processor;
a memory storing instructions that, when executed by the processor, cause the device to:
generate the cryptographically generated verification code for the product,
obtain the spatiotemporal data;
associate the spatiotemporal data with the verification code;
link the verification code and associated spatiotemporal data to a distinct digital identifier comprising metadata that identifies the device and a legal entity controller of the device;
instruct the transmitter to transmit the verification code and associated metadata to a distributed ledger system for storage as an immutable record.

The claimed verification code manufacturing device provides a robust technical framework for secure, traceable, and tamper-resistant product authentication. The arrangement of the processor and memory allows the device to execute cryptographic operations that generate a distinct and secure verification code, ensuring the integrity and authenticity of each product unit at the moment of creation. By additionally associating spatiotemporal data, such as the precise time and location of generation, with the verification code, the system creates a verifiable link between the product and the specific manufacturing event that produced it. This enhances traceability, accountability, and reliable provenance tracking throughout the supply chain

A further advantage arises from linking the verification code and its spatiotemporal data to a distinct digital identifier that incorporates both the unique identity of the device and metadata identifying the legal entity controlling it. This binding prevents unauthorized or rogue devices from producing counterfeit verification codes and ensures that each code can be confidently attributed to a known, authenticated source. The combination of device identity, legal-entity metadata, and cryptographically generated verification data strengthens trust in the authentication process and supports automated verification workflows.

Once generated, the verification code and associated metadata are transmitted to a distributed ledger system, where they are stored as an immutable record. The decentralized and tamper-evident nature of such ledgers, such as blockchain, prevents subsequent modification or deletion of the authentication data, ensuring long-term integrity and auditability. This immutable storage mechanism reinforces confidence in the verification process, particularly in environments where high levels of security and data integrity are required.

Together, these features provide a comprehensive and technologically advanced method for product authentication. The system minimizes the risk of counterfeiting, enhances supply-chain visibility, and enables reliable verification of product provenance at any point in the distribution process. In practical use, for example in supply-chain management, the device allows products to be authenticated at multiple checkpoints, ensuring that only genuine items reach distributors, regulators, or end consumers.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a flowchart of a method according to an embodiment of the invention for authenticating a product,

FIG. 2 depicts another embodiment of a flowchart where the method is applied during the logistics process of transporting a physical product along a supply chain,

FIG. 3 illustrates a system for product authentication, the system comprising a verification code manufacturing device and a spatiotemporal data module,

FIGS. 4a-c illustrate an example of how metadata discussed in relation to previous figures is obtained, and

FIG. 5 illustrates an alternative embodiment of a system in accordance with the present disclosure.

### DESCRIPTION OF EMBODIMENTS

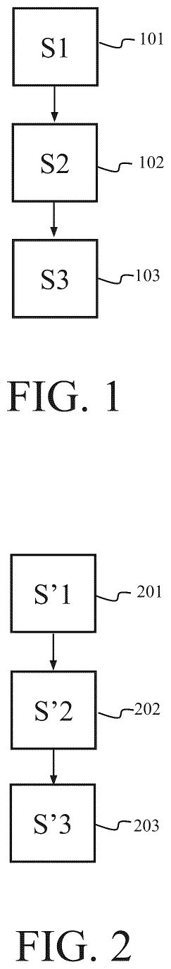

FIG. 1 illustrates a flowchart of a method according to an embodiment of the invention for authenticating a product, where in this embodiment the product comprises a physical item, such as an article of clothing, furniture, footwear, or any other manufactured goods.

In a first step (S1) 101, a verification code is generated for the product. The verification code may take the form of a QR code, barcode, or cryptographic string, and may be printed on a label, embedded into packaging, or integrated into an RFID tag physically attached to the product.

In a second step (S2) 102, spatiotemporal data for the product (e.g., production location, manufacturing time, or batch details) is linked to the verification code. The verification code is configured so that it can be scanned by a scanning device, such as a smartphone or dedicated scanner, and subsequently used for spatiotemporal verification of the product.

In a third step (S3) 104, a computer device associated with a unique digital identifier is used. The unique digital identifier comprises metadata, including (i) metadata that links the computer device to a legal entity controller (for example, the manufacturer, brand owner, or authorized production facility), (ii) metadata uniquely identifying the computer device itself, and (iii) the relevant spatiotemporal data.

In one alternative embodiment, the verification code is generated directly by a portable computer device that is associated with such a unique digital identifier. Because the identifier binds both the legal entity controller and the specific device used, unauthorized code generation is prevented. This ensures that fraudulent codes cannot be created without both the authorized entity and the corresponding registered device being involved.

FIG. 2 depicts another embodiment of a flowchart where the method is applied during the logistics process of transporting a physical product along a supply chain. This embodiment highlights how spatiotemporal data and a non-fungible product token (NFT-p) can be continuously updated to ensure that the authenticity of the product is traceable at every stage of its journey.

In step (S′1) 201, a verification code is generated for the product at the manufacturing site. The verification code is uniquely tied to a digital identifier of the verification code manufacturing device, ensuring that it cannot be duplicated or reproduced without detection. At this stage, an initial NFT-p is created, which serves as a digital representation of the product. The NFT-p includes metadata such as, but not limited to, the manufacturing date, time, and location, as well as product authentication data and brand information.

In step (S′2) 202, the product is scanned at a distribution center or intermediate checkpoint. Each time the product is scanned, a new NFT-p may be created for each scan and linked to the original token, thereby preserving a chronological chain of custody, and each NFT-p is updated with new spatiotemporal data, such as the time of arrival, the geographical location of the checkpoint, or customs clearance details. This effectively creates a secure and tamper-resistant digital trail stored within the NFT-p, ensuring that all transfers, scans, and movements are cryptographically bound to the product. In one embodiment, a new NFT-p may be created for each scan and linked to the original token, thereby preserving a chronological chain of custody.

In step (S′3) 203, the accumulated NFT-p metadata, including spatiotemporal data, is made accessible through a web portal. Authorized stakeholders, such as customs authorities, logistics providers, retailers, or end consumers, can access this portal to verify the product's authenticity and trace its movements through the supply chain. Because the NFT-p is immutable and cryptographically secured, fraudulent attempts to introduce counterfeit products can be detected immediately: a fake product may replicate a single verification code, but it cannot replicate the complete, authenticated NFT-p history that spans the full supply chain.

### EXAMPLE

Consider a shipment of 1,000 luxury handbags produced at a factory in Milan. Each handbag is assigned a unique verification code and an NFT-p. When the handbags arrive at a European distribution hub in Paris, they are scanned, and the NFT-p for each handbag is updated with spatiotemporal data confirming the exact arrival time and location. At U.S. customs, the handbags are scanned again, and new NFT-p updates are added, reflecting customs clearance and entry into the U.S. market. If a fraudulent handbag enters with a copied QR code, its NFT-p would lack this chain of updates and would be flagged as invalid. Finally, when a consumer purchases a handbag in New York, they can scan the verification code to view the entire tamper-resistant NFT-p history, from Milan to Paris to U.S. customs, giving them 100% confirmation of authenticity.

By linking each product to a dynamic NFT-p that is updated at every scan, the method provides end-to-end, tamper-resistant traceability across the supply chain. Unlike static verification codes, the NFT-p ensures that authenticity is based not only on an initial identifier but also on an evolving, immutable record of spatiotemporal events. This makes it virtually impossible for counterfeiters to introduce fraudulent products, as they cannot recreate the complete NFT-p history tied to the legitimate product.

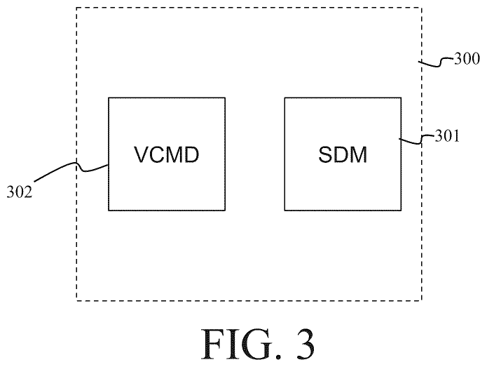

FIG. 3 illustrates a system 300 for product authentication, the system comprising a verification code manufacturing device 301 and a spatiotemporal data module 302.

The verification code manufacturing device (VCMD) 301 is configured to generate a verification code for the product. The verification code may, for example, be realized as a QR code, a barcode, a cryptographic string, or an RFID-based identifier. In one embodiment, the code may be printed on a label or packaging of the product, or alternatively embedded into a physical component of the product itself, such as a sewn-in fabric tag for clothing, a metal plate for machinery, or an integrated chip for electronics.

The spatiotemporal data module (SDM) 302 is configured to obtain spatiotemporal data associated with the product (e.g., location of manufacturing, date and time of assembly, or batch number) and to link such spatiotemporal data to the generated verification code. By this configuration, the verification code is enriched with contextual data that can later be scanned, for example by a smartphone application or a dedicated scanner device, and used to perform spatiotemporal verification of the product. This allows a verifying party to confirm not only the authenticity of the product, but also its production origin and timeline.

In one embodiment, the verification code manufacturing device 301 is associated with a unique digital identifier, which may be securely stored in a memory of the device. The unique digital identifier comprises metadata, including metadata linking the device to a legal entity controller of the device (such as the manufacturer, brand owner, or an authorized production facility), metadata uniquely identifying the device itself (e.g., a serial number or cryptographic hardware fingerprint), and spatiotemporal data relevant to the production of the product.

This configuration ensures that the process of generating the verification code cannot be carried out without both the authorized legal entity and the specific registered device being involved. For example, a portable handheld device used on a production line may generate verification codes only if it is authenticated to a brand owner's server. In this way, fraudulent devices or unauthorized facilities cannot produce valid verification codes.

In another embodiment, the spatiotemporal data module 302 may be implemented as a dedicated sub-system within a manufacturing line, continuously logging production events (e.g., timestamped machine operations, sensor readings, or batch transfers). The logged data is automatically associated with the verification code, thereby creating a secure and traceable link between the physical product, its production context, and the verification system.

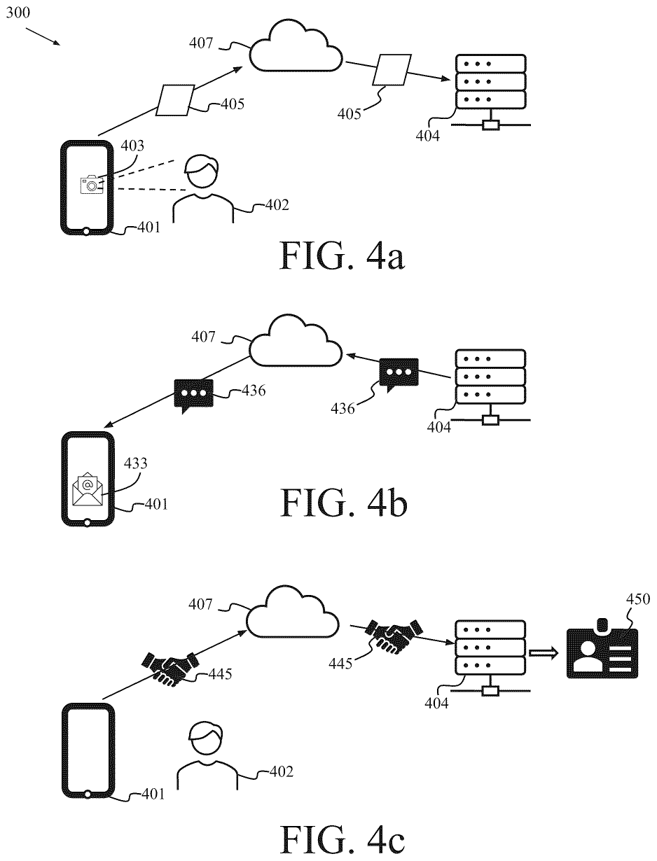

FIGS. 4a-c illustrate an example of how the metadata is obtained by the system 300 according to the present invention. In this embodiment, a computer device 401 is operated by a legal entity controller 402 to generate a verification code.

First, characteristic data, such as biometric information (e.g., a fingerprint, facial scan, or voice sample), is captured by the device 401. This biometric data is then bundled together with information that uniquely identifies the device itself, forming a data package 405. The data package is transmitted to a computer system 404 for processing.

Once the computer system 404 receives the package, it generates a verification message 436 and forwards it to the legal entity controller 402. The legal entity controller 402 confirms the request through a suitable channel, such as email, push notification, or text message 433. After confirmation, a digital confirmation package 445 is sent back to the computer system 404.

Upon receiving this confirmation, the computer system 404 creates a unique identifier 450 linked to the legal entity controller 402. This identifier, combined with the device identification data, forms the unique digital representation 450 of the device.

In preferred embodiments, additional metadata such as spatiotemporal data 411 (e.g., the device's geolocation and timestamp) can be included to provide stronger contextual verification. The resulting unique digital representation 450 may then be stored locally on the device's memory and/or remotely in the system's memory.

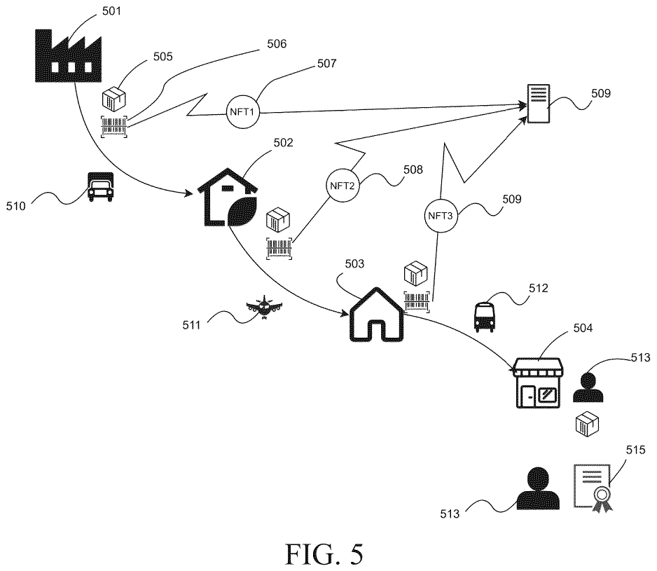

FIG. 5 illustrates an alternative embodiment of a system 500 in accordance with the present disclosure. In this embodiment, the product-similar to the embodiments described with reference to FIGS. 1 and 2 consists of a physical item 505 in combination with a verification code 506 that is physically affixed to the product 505.

The physical product 505 is transported along a supply chain originating from the manufacturing site 501 and moving toward an endpoint such as a retail store 504. Along the way, the product typically passes through one or more intermediate nodes such as distribution centers 502 and 503, utilizing various modes of transport 510-512.

At each distribution center, the verification code 506 can be scanned by an authorized scanning device. Each scan triggers the generation of a new NFT-p code (507-509), here labeled T1 through T3. Each newly generated NFT-p code is an electronic, unique authentication record that incorporates at least updated spatiotemporal metadata-specifically, the location and timestamp of where the scan occurred. This authentication process is carried out by an NFT system 530, which may be any type of a digital platform that creates and manages unique, tamper-proof records on a blockchain to track and verify a product's authenticity and journey through the supply chain, thereby continuously enriching the digital history of the product as it moves through the supply chain.

When the physical product 505 is ultimately purchased by an end user 513, the system issues a digital certificate 515. This certificate contains essential product information, such as the brand name, manufacturing origin, and authenticated ownership details of the purchaser. The result is a verifiable digital record that securely ties the physical product to its lifecycle history and its rightful owner

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A method of product authentication, comprising:
generating, by a verification code manufacturing device having a processor, a cryptographically generated verification code for the product;
linking, by a processing unit, spatiotemporal data for the product to the verification code, the spatiotemporal data including at least one of a timestamp and a geographic coordinate corresponding to a location and a time of generation of the verification code, where the verification code is configured to be scanned, by a scanning device executing verification instructions, and utilized in performing spatiotemporal verification for the product;
wherein generating the verification code comprises:
using a computer device associated with a unique digital identifier, the unique digital identifier comprising metadata, including:
metadata that links the computer device to a legal entity controller of the computer device, metadata that uniquely identifies the computer device, and
the spatiotemporal data,
wherein the metadata is stored on a distributed ledger system, thereby providing an immutable record of the verification code and associated spatiotemporal data.

2. The method according to claim 1, wherein the metadata is generated by:
obtaining, via the computer device, characteristic data of the legal entity controller;
transmitting, to a computer system connected to the computer device, the characteristic data together with data uniquely identifying the computer device;
generating, by the computer system, a verification message based on the received data;
transmitting the verification message to the computer device; and
upon receiving confirmation of the verification message from the legal entity controller;
using the characteristic data of the legal entity controller together with the data uniquely identifying the computer device as said metadata.

3. The method according to claim 1, wherein the legal entity controller comprises at least one of: a natural person, a company, a corporation, a partnership, a joint venture, a consortium, a government agency, a municipality, a non-profit organization, a research institute, a trust, a foundation, a cooperative, or another juridical entity having ownership, control, or administrative responsibility for the computer device.

4. The method according to claim 1, wherein the unique digital identifier for the computer device is stored locally on the computer device and/or remotely by the computer system, where the method further comprises, prior to generating a verification code for the product, a pre-step comprising:
capturing characteristic data of an operator operating the computer device;
comparing the captured characteristics data with the stored characteristics data of the legal entity controller, where in case of a match;
generating the verification code for the product.

5. The method according to claim 4, further comprising:
comparing the spatiotemporal location data of the computer device with the spatiotemporal location data associated with the unique digital identifier;
wherein the step of generating the verification code for the product is further based on a match of the spatiotemporal location data.

6. The method according to claim 1, wherein the product is a physical product and where the verification code is physically attached to the product.

7. The method according to claim 1, wherein the digital identifier comprises a non-fungible token (NFT) representing the computer device.

8. The method according to claim 7, further comprising a non-fungible product token (NFT-p) associated with the product, the token comprising metadata including one or more of:
product authentication data;
product certification data;
transport-related information associated with the product;
distribution center-related information associated with the product;
retail-related information associated with the product;
purchase-related information associated with the product;
manufacturing-related information associated with the product;
origin or provenance information of the product;
quality control or inspection data associated with the product;
warranty or service-related information associated with the product;
regulatory or compliance-related information associated with the product;
customs or import/export-related information associated with the product;
ownership history or transfer records of the product;
maintenance or repair-related information associated with the product;
usage or operational data associated with the product;
recycling, disposal, or sustainability-related information associated with the product.

9. The method according to claim 8, wherein new NFT-p is created each time the NFT-p is scanned during a transport, where the new NFT-p contains at least updated spatiotemporal data where the scanning took place.

10. The method according to claim 1, further comprising obtaining, via a computer device operated by a user, characteristic data of the user to generate a unique identifier (ID) or cryptographic ID for the user, adapted to serve as a unique digital signature for the user within the computer system.

11. A system for product authentication, comprising:
a verification code manufacturing device having a processor for generating a cryptographically generated verification code for the product;
a spatiotemporal data module configured to obtain spatiotemporal data associated with the product and link the spatiotemporal data to the verification code, the spatiotemporal data including at least one of a timestamp and a geographic coordinate corresponding to a location and a time of generation of the verification code, where the verification code is configured to be scanned, by a scanning device executing verification instructions, and utilized in performing spatiotemporal verification for the product;
wherein the verification code manufacturing device is associated with a unique digital identifier, the unique digital identifier comprising metadata, including metadata that links the computer device to a legal entity controller of the computer device, metadata that uniquely identifies the computer device, and the spatiotemporal data,
wherein the metadata is stored on a distributed ledger system, thereby providing an immutable record of the verification code and associated spatiotemporal data.

12. The system according to claim 11, wherein the distributed ledger system comprises a blockchain system in which verification records for the product are organized into blocks, each block comprising a plurality of transactions and a cryptographic reference to a preceding block, thereby forming a tamper-evident chain of blocks representing spatiotemporal verification events.

13. The system according to claim 11, wherein the system further comprises a processor configured to generate a digital certificate upon purchase of the product, the certificate including at least the brand name of the product, place of manufacture, and purchaser information.

14. The system according to claim 11, wherein the metadata is obtained by:
obtaining, via the computer device, characteristic data of the legal entity controller;
transmitting, to a computer system connected to the computer device, the characteristic data together with data uniquely identifying the computer device;
generating, by the computer system, a verification message based on the received data;
transmitting the verification message to the computer device; and
upon receiving confirmation of the verification message from the legal entity controller;
using the characteristic data of the legal entity controller together with the data uniquely identifying the computer device as said metadata,
wherein the legal entity controller comprises at least one of: a natural person, a company, a corporation, a partnership, a joint venture, a consortium, a government agency, a municipality, a non-profit organization, a research institute, a trust, a foundation, a cooperative, or another juridical entity having ownership, control, or administrative responsibility for the computer device,
wherein the unique digital identifier associated with the computer device is stored in a memory resource local to the computer device and/or in a memory resource remote from the computer device and accessible by the computer system,
where the system further comprises a biometric capturing device configured to, prior to generating a verification code for the product, capturing characteristic data of an operator operating the computer device,
a processor configured for comparing the captured characteristics data with the stored characteristics data of the legal entity controller and generating, in case of a match, the verification code for the product,
the processor is further configured for comparing the spatiotemporal location data of the computer device with the spatiotemporal location data associated with the unique digital identifier, where the step of generating the verification code for the product is further based on a match of the spatiotemporal location data.

15. The system according to claim 11, wherein the verification code manufacturing device comprises:
a processor;
a transmitter,
a memory storing instructions that, when executed by the processor, cause the device to:
generate the cryptographically generated verification code for the product,
obtain the spatiotemporal data;
associate the spatiotemporal data with the verification code;
link the verification code and associated spatiotemporal data to a distinct digital identifier comprising metadata that identifies the device and a legal entity controller of the device;
instruct the transmitter to transmit the verification code and associated metadata to a distributed ledger system for storage as an immutable record.
